(19) United States
(12) Patent Application Publication
(10) Pub. No.: US 2026/0150050 A1
(43) Pub. Date: May 28, 2026

(54) METHOD AND APPARATUS FOR WAKING UP TRANSCEIVER, AND STORAGE MEDIUM AND CHIP

(71) Applicant: Beijing Xiaomi Mobile Software Co., Ltd., Beijing (CN)

(72) Inventor: Yanhua LI, Beijing (CN)

(21) Appl. No.: 19/122,035

(22) PCT Filed: Oct. 20, 2022
(86) PCT No.: PCT/CN2022/126529

§ 371 Date: Apr. 17, 2025

(51) Int. Cl. H04W 52/02; H04W 72/0453

(52) U.S. Cl. CPC H04W 52/0235; H04W 72/0453

(57) ABSTRACT

A method for waking up a transceiver is performed by a terminal, wherein the terminal includes a first transceiver and a first receiver, and the method includes: in a case that the first transceiver is in a sleep state, receiving a wake-up message sent by a network device through the first receiver, to wake up the first transceiver.

### CROSS-REFERENCE TO RELATED APPLICATION(S)

The present application is a U.S. National Stage of International Application No. PCT/CN2022/126529 filed on Oct. 20, 2022, the disclosure of which is incorporated herein by reference in its entirety.

### TECHNICAL FIELD

The present disclosure relates to the field of communication technology, and in particular, to a method and apparatus for waking up a transceiver, and a storage medium and chip.

### BACKGROUND

In wireless communication systems, in order to reduce the power consumption of terminals, 3rd Generation Partnership Project (3GPP) introduced power-saving signals, such as wake-up signals (WUS). The WUS signal is a low-power detection signal. If the terminal detects the WUS signal, it can monitor the physical downlink control channel (PDCCH). If the terminal does not detect the WUS, it can skip monitoring the PDCCH.

However, in related technologies, although the monitoring of WUS and PDCCH by the transceiver using the above solution can reduce the power consumption of the terminal to a certain extent, there is still a need to further improve the power saving performance of the terminal.

### SUMMARY

According to a first aspect of embodiments of the present disclosure, a method for waking up a transceiver is provided, which is applied to a terminal. The terminal includes a first transceiver and a first receiver. The method includes:
in a case that the first transceiver is in a sleep state, receiving a wake-up message sent by a network device through the first receiver, where the wake-up message is used to wake up the first transceiver.

According to a second aspect of embodiments of the present disclosure, a method for waking up a transceiver is provided, which is applied to a network device. The method includes:
sending a wake-up message to a terminal, where the wake-up message is used to instruct the terminal to wake up the first transceiver in response to the wake-up message being received by the first receiver.

According to a third aspect of embodiments of the present disclosure, a device for waking up a transceiver is provided, comprising:
a processor; and
a memory for storing processor-executable instructions.

The processor is configured to perform the steps of the method for waking up a transceiver provided in the first aspect of the present disclosure.

According to a fourth aspect of embodiments of the present disclosure, a device for waking up a transceiver is provided, comprising:
a processor; and
a memory for storing processor-executable instructions.

The processor is configured to perform the steps of the method for waking up a transceiver provided in the second aspect of the present disclosure.

It should be understood that the above general description and the detailed description below are only exemplary and explanatory, and cannot limit the present disclosure.

### BRIEF DESCRIPTION OF THE DRAWINGS

The drawings herein are incorporated into and constitute a part of the specification, illustrate embodiments consistent with the present disclosure, and are used together with the specification to explain the principles of the present disclosure.

FIG. 1 is a schematic diagram of a communication system according to an example embodiment.

FIG. 2 is a flow chart of a method for waking up a transceiver according to an example embodiment.

FIG. 3 is a flow chart of a method for waking up a transceiver according to an example embodiment.

FIG. 4 is a flow chart of a method for waking up a transceiver according to an example embodiment.

FIG. 5 is a flow chart of a method for waking up a transceiver according to an example embodiment.

FIG. 6 is a flow chart of a method for waking up a transceiver according to an example embodiment.

FIG. 7 is a block diagram of an apparatus for waking up a transceiver according to an example embodiment.

FIG. 8 is a block diagram of an apparatus for waking up a transceiver according to an example embodiment.

FIG. 9 is a block diagram of an apparatus for waking up a transceiver according to an example embodiment.

FIG. 10 is a block diagram of an apparatus for waking up a transceiver according to an example embodiment.

FIG. 11 is a block diagram of a device for waking up a transceiver according to an example embodiment.

### DETAILED DESCRIPTION OF THE EMBODIMENTS

Here, example embodiments will be described in detail, and examples thereof are shown in the accompanying drawings. When the following description refers to the drawings, unless otherwise indicated, the same numbers in different drawings represent the same or similar elements. The embodiments described in the following example embodiments do not represent all the embodiments consistent with the present disclosure. Instead, they are only examples of devices and methods consistent with some aspects of the present disclosure as detailed in the attached claims.

It should be noted that all the operations to acquire signals, information or data in the present disclosure are carried out under the premise of complying with the corresponding data protection laws and policies of the country of residence and with the authorization given by the owner of the corresponding device.

In the description of the present disclosure, the terms, such as “first”, “second”, etc., are used to distinguish similar objects, and do not have to be understood as a specific order or sequence. In addition, in the description of the reference drawings, the same reference numeral in different drawings represents the same element unless otherwise stated.

In the description of the present disclosure, unless otherwise specified, “a plurality of” means two or more than two, and other quantifiers are similar. “At least one item”, “one or more items”, or similar expressions refer to any combination of these items, including any combination of single items or plural items. For example, at least one item may represent any number. For another example, one or more of a, b and c may represent: a, b, c, a-b, a-c, b-c, or a-b-c, where a, b, c may be single or multiple. “And/or” is a kind of association relationship that describes the associated objects, indicating that there may be three relationships. For example, A and/or B may represent: A exists alone, A and B exist at the same time, and B exists alone, where A and B may be singular or plural.

Although the operations or steps are described in a specific order in the drawings in the embodiments of the present disclosure, it should not be understood as requiring the operations or steps to be performed in the specific order shown or in a serial order, or requiring the execution of all the operations or steps shown to obtain the desired results. In the embodiments of the present disclosure, the operations or steps may be performed in series; the operations or steps may also be performed in parallel; or some of the operations or steps may be performed.

The implementation environment of the embodiments of the present disclosure is first introduced below.

The technical solution of the embodiments of the present disclosure may be applied to various communication systems. The communication system may include one or more of the 4th Generation (4G) communication system, the 5th Generation (5G) communication system, and other future wireless communication systems (such as 6G). The communication system may also include one or more of a public land mobile network (PLMN), a device-to-device (D2D) communication system, a machine-to-machine (M2M) communication system, an Internet of Things (IoT) communication system, a vehicle-to-everything (V2X) communication system, or other communication systems.

FIG. 1 is a schematic diagram of a communication system according to an example embodiment. As shown in FIG. 1, the communication system may include a terminal 150 and a network device 160. The communication system may be used to support 4G network access technology, such as Long Term Evolution (LTE) access technology, or 5G network access technology, such as New Radio Access Technology (New RAT), or other future wireless communication technologies. It should be noted that in the communication system, the number of network devices and terminals may be one or more. The number of network devices and terminals in the communication system shown in FIG. 1 is only an adaptive example, and the present disclosure is not limited to it.

The network device in FIG. 1 may be used to support terminal access. For example, the network device may be an evolutional Node B (eNB or eNodeB) in LTE; the network device may also be the next generation Node B (gNB or gNodeB) in a 5G network; the network device may also be a NG Radio Access Network (NG-RAN) device in a 5G network; the network device may also be a base station in a future evolved public land mobile network (PLMN), a broadband network service gateway (BNG), an aggregation switch, or a non-3rd Generation Partnership Project (3GPP) access device, etc. Optionally, the network device in the embodiments of the present disclosure may include various forms of base stations, such as: macro base stations, micro base stations (also called small stations), relay stations, access points, 5G base stations or future base stations, satellites, Transmitting and Receiving Point (TRP), Transmitting Point (TP), mobile switch centers, Device-to-Device (D2D), Machine-to-Machine (M2M), Internet of Things (IoT), vehicle-to-everything (V2X), or other devices that play the role of base stations in other communications, etc. The embodiments of the present disclosure are not specifically limited in this regard. For the convenience of description, in all the embodiments of the present disclosure, the devices that provide wireless communication functions for terminals are collectively referred to as network devices or base stations.

The terminal in FIG. 1 may be an electronic device that provides voice or data connectivity. For example, the terminal may also be referred to as a User Equipment (UE), a Subscriber Unit, a Mobile Station, a Station, a Terminal, etc. For example, the terminal may include a smart phone, a smart wearable device, a smart speaker, a smart tablet, a wireless modem, a Wireless Local Loop (WLL) station, a Personal Digital Assistant (PDA), a Customer Premise Equipment (CPE), etc. With the development of wireless communication technology, devices that can access a communication system, can communicate with network devices of a communication system, can communicate with other objects through a communication system, or can directly communicate between two or more devices can all be terminals in the embodiments of the present disclosure. For example, they may be terminals and cars in smart transportation, household devices in smart homes, power meter reading instruments in smart grids, voltage monitoring instruments, environmental monitoring instruments, video monitoring instruments in smart security networks, cash registers, etc. In the embodiments of the present disclosure, the terminal can communicate with the network device. Multiple terminals can also communicate with each other. The terminal may be statically fixed or mobile, and the present disclosure is not limited to it.

In some embodiments of the present disclosure, the terminal may include a first transceiver and a first receiver. The first transceiver may be used to communicate with the network device. For example, the terminal may send signals to the network device and receive signals from the network device through the first transceiver. The first transceiver may be one or more. The first receiver may be a receiver for receiving a wake-up message sent by the network device. The wake-up message may be a message or signal for waking up the first transceiver. For example, the wake-up message may be a Low Power Wake-Up Signal.

For example, the first transceiver may include the main radio of the terminal, and the first receiver may be a separate receiver other than the main radio of the terminal. For example, the first receiver may be a Low Power Wake-Up Receiver.

In some embodiments, the first receiver may be used only to receive signals sent by the network device. For example, it can only be used to receive the wake-up message from the network device, so that the power consumption of the terminal can be minimized when the first receiver is working.

In some other embodiments, the first receiver may be used for both receiving the signal sent by the network device and sending the signal to the network device.

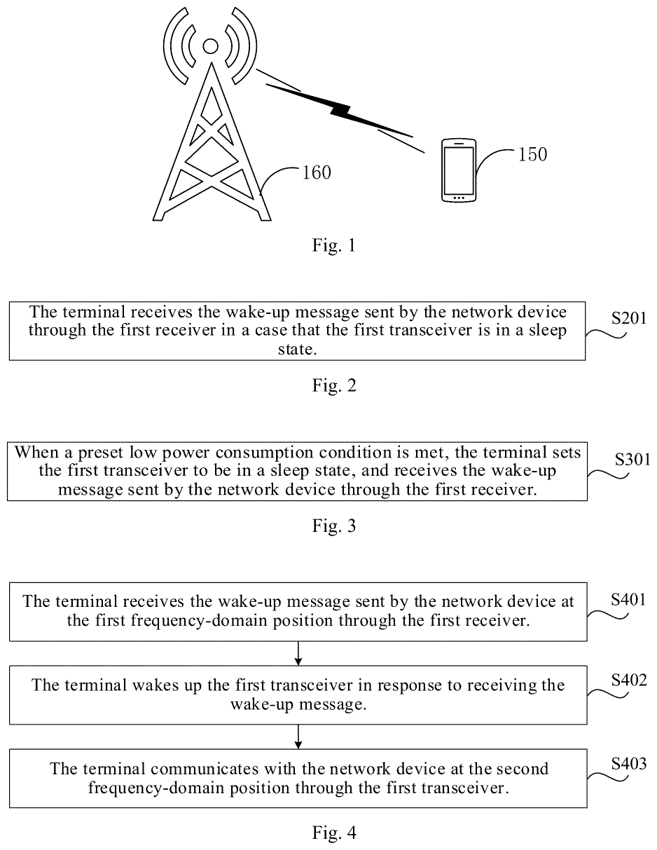

FIG. 2 is a flow chart of a method for waking up a transceiver according to an example embodiment. The method can be applied to the terminal in the above communication system. As shown in FIG. 2, the method may include S201.

In S201, the terminal receives the wake-up message sent by the network device through the first receiver in a case that the first transceiver is in a sleep state.

The wake-up message can be used to wake up the first transceiver.

In some embodiments, the wake-up message may be a wake-up signal. The wake-up signal may use the wake-up signal already specified in the current protocol, such as WUS, DCP (DCI for power saving), or PEI (Paging Early Indication), etc. The wake-up signal may also be a newly-defined signal type. For example, the wake-up signal may also be a new low power saving signal LP-WUS.

In other embodiments, the wake-up message may include a wake-up indication and/or a wake-up parameter, and the terminal may wake up the first transceiver according to the wake-up indication and/or the wake-up parameter.

It should be noted that the first transceiver of the terminal may have one or more states. For example, the states may include a sleep state and a working state. The first transceiver being in the working state may indicate that the terminal can communicate with the network device through the first transceiver.

In some embodiments, other states except the working state of the first transceiver may be referred to as sleep states.

In some implementations, the first transceiver being in the sleep state may be used to indicate that the first receiver is completely turned off. For example, the first transceiver is in a power-off state. For another example, although the first transceiver is powered on, it does not receive or send signals at all.

In other implementations, the first transceiver being in the sleep state may be used to indicate that the first receiver is partially turned off. For example, the case may be that only the sending function is turned off and the receiving function is retained. For another example, the sending function may be turned off, and the receiving function is only periodically turned on to receive the signal sent by the network device. For another example, the transceiving function may be periodically turned on and off. That is, the transceiving function is turned on within the first time of a preset period, and the transceiving function is turned off at other times except the first time within the preset period.

In the above method, the terminal includes a first transceiver and a first receiver. When the first transceiver is in the sleep state, the first receiver receives a wake-up message sent by the network device. The wake-up message can be used to wake up the first transceiver. In this way, by setting a separate, first receiver to receive the wake-up signal, the management of the terminal working state can be realized, and the power saving performance of the terminal can be improved when the first transceiver is in the sleep state.

In some embodiments of the present disclosure, when the terminal is in a non-connected state, the terminal may receive the wake-up message sent by the network device through the first receiver.

For example, the state of the terminal may include a connected state and a non-connected state, where the non-connected state may include an idle state, a deactivated state or other states that are not in a connected state. When the terminal is in a connected state, it can communicate with the network device through the first transceiver, and at this time, the first receiver may be working or not. When the terminal is in a non-connected state, the first receiver may be working. That is, the terminal may receive a wake-up message through the first receiver.

It should be noted that when the terminal is in a non-connected state, the first transceiver may be in a working state or in a sleep state. The present disclosure is not limited in this regard.

FIG. 3 is a flow chart of a method for waking up a transceiver according to an example embodiment. As shown in FIG. 3, the method may include S301.

In S301, the terminal sets the first transceiver to be in a sleep state when a preset low power consumption condition is met, and receives a wake-up message sent by the network device through the first receiver.

For example, setting the first transceiver to be in a sleep state may include turning off the first transceiver.

The preset low power consumption condition may include any one of the following sleep conditions 1 and 2.

Sleep condition 1, the terminal is in a non-connected state.

For example, the terminal may set the first transceiver to be in a sleep state when it is in a non-connected state or enters a non-connected state from a connected state, and monitor the wake-up message sent by the network device through the first receiver.

Sleep condition 2: the terminal is in a non-connected state and does not detect the target paging message within the target detection time.

For example, the terminal may monitor the target paging message sent by the network device when it is in a non-connected state. If the terminal does not detect the target paging message within the target detection time, it can actively set the first transceiver to be in a sleep state and monitor the wake-up message sent by the network device through the first receiver.

It should be noted that the target paging message may be used to represent the paging message sent by the network device to the terminal; the target paging message may also be used to represent any paging message sent by the network device. The target detection time may be any preset time. For example, it may be a time agreed upon by the protocol, or a time configured by the terminal.

In this way, by detecting the paging message, a low power consumption state can be actively entered to improve the power saving performance of the terminal.

It should be noted that when the terminal sets the first transceiver to be in a sleep state and receives a wake-up message sent by the network device through the first receiver, it can be considered that the terminal enters a low power wake-up signal monitoring state.

In some embodiments of the present disclosure, the terminal may receive a wake-up message sent by the network device at a first frequency-domain position through the first receiver.

In some implementations, the first frequency-domain position may include the first downlink initial Bandwidth Part (BWP) at which the network device sends a wake-up message. For example, the first downlink initial BWP may be a BWP configured by the network device for sending a wake-up message.

In some implementations, when the first frequency-domain position is different from the frequency-domain position used before the terminal enters the low power wake-up signal monitoring state, frequency domain switching may be performed. That is, the first transceiver is set to be in a sleep state, and switching is performed to the first frequency-domain position to listen for the wake-up message.

For example, if the first frequency-domain position is the first downlink initial BWP, BWP switching may be performed when the first downlink initial BWP is different from the initial BWP used before the terminal enters the low power wake-up signal monitoring state. That is, the first transceiver is set to be in a sleep state, and switching is performed to the first downlink initial BWP to monitor the wake-up message.

In other implementations, when the first frequency-domain position is the same as the frequency-domain position used before the terminal enters the low power wake-up signal monitoring state, there is no need to perform frequency-Attorney domain switching. That is, the first transceiver is set to be in a sleep state, and the wake-up message is directly monitored at the first frequency-domain position.

In some embodiments of the present disclosure, the above-mentioned first frequency-domain position may be one or more.

In some implementations, the above-mentioned first frequency-domain position may be one, and the terminal may directly receive the wake-up message sent by the network device at the first frequency-domain position.

In other implementations, the above-mentioned first frequency-domain position may be multiple, and the terminal may determine a first frequency-domain position from the multiple first frequency-domain positions as the target frequency-domain position, and receive the wake-up message sent by the network device at the target frequency-domain position.

For example, the terminal may determine a first frequency-domain position from the multiple first frequency-domain positions as the target frequency-domain position according to the terminal identifier. For example, the terminal may determine the number of positions regarding the first frequency-domain position, sort the multiple first frequency-domain positions, acquire a first modulus after taking the modulus according to the terminal identifier and the number of positions, and use the first frequency-domain position sorted at the first modulus position as the target frequency-domain position.

It should be noted that the terminal identifier may also be called as User Equipment ID (UEID), and the UEID may include any one or more of International Mobile Equipment Identity (IMEI), International Mobile Subscriber Identity (IMSI), Temporary Mobile Subscriber Identity (TMSI), Radio Network Temporary Identity (RNTI), and Globally Unique Temporary UE Identity (GUTI).

It should be noted that the terminal may acquire the one or more first frequency-domain positions through the broadcast signaling sent by the network device. The terminal may also acquire the one or more first frequency-domain positions through the dedicated signaling sent by the network device to the terminal.

In this way, the first frequency-domain position can be flexibly determined, and the wake-up message can be received at the first frequency-domain position.

In some embodiments of the present disclosure, the above-mentioned first frequency-domain position (for example, the first downlink initial BWP) may be determined by any one of the following methods.

Method 1 for determining the first frequency-domain position: in response to receiving the first message sent by the network device, the first frequency-domain position (for example, the first downlink initial BWP) is determined according to the first message.

The first message may include the first frequency-domain position (for example, the first downlink initial BWP).

In some embodiments, the first message may be a dedicated message corresponding to the terminal. For example, the first message may be a preset dedicated signaling corresponding to the terminal. The preset dedicated signaling may include an Radio Resource Control (RRC) connection release message or an RRC reconfiguration message. For example, when the terminal enters a non-connected state from a connected state (for example, when the connection is released), the terminal may receive the first frequency-domain position through a preset dedicated signaling.

In some other embodiments, the first message may be a broadcast signaling from a network device. For example, the broadcast signaling may include a Master Information Block (MIB) and/or a System Information Block (SIB).

For example, the terminal may use the wake-up message specific downlink initial BWP (e.g., LP-WUS-initial DL BWP) sent by the network device through broadcast signaling as the first downlink initial BWP.

For another example, when the terminal is a normal user, the terminal may use the downlink initial BWP (e.g., initial DL BWP), which is configured for normal users and sent by the network device through broadcast signaling, as the first downlink initial BWP.

For another example, when the terminal is a Reduced Capability (Redcap) user, the terminal may use the Redcap specific downlink initial BWP (e.g., Redcap specific initial DL BWP), which is configured by the network device for Redcap users through broadcast signaling, as the first downlink initial BWP.

Method 2 for determining the first frequency-domain position: the first frequency-domain position (e.g., first downlink initial BWP) is determined according to the first preset frequency-domain position.

In some embodiments, the first preset frequency-domain position may be a specific frequency-domain position agreed upon by the protocol. For example, according to the protocol agreement, the network device sends a wake-up message at the first preset frequency-domain position, and the terminal receives the wake-up message at the first preset frequency-domain position.

In other embodiments, the first preset frequency-domain position may be a downlink initial BWP including COSESET0 and/or SSB. For example, the terminal may use the downlink initial BWP including COSESET0 and/or SSB as the above-mentioned first downlink initial BWP.

It should be noted that the COSESET0 may be a Control Resource Set 0, which is a group of physical resources in a specific frequency-domain position in the downlink resources, and is a PDCCH specifically used to send a decoding SIB message. The SSB may be a Synchronization Signal and PBCH block (referred to as SSB).

In other embodiments, the first preset frequency-domain position may be a downlink initial BWP for monitoring paging messages. For example, the terminal may use the downlink initial BWP for monitoring paging messages as the above-mentioned first downlink initial BWP. In this way, the terminal can monitor the wake-up message in the first downlink initial BWP, and continue in the first downlink initial BWP after waking up.

In some other embodiments, for Redcap users: if the Redcap specific downlink initial BWP includes COSESET0 and/or SSB, the above-mentioned first downlink initial BWP is the Redcap specific downlink initial BWP; otherwise, the above-mentioned first downlink initial BWP is the initial DL BWP configured by broadcast signaling (such as MIB or SIB1).

In this way, the first preset frequency-domain position can be determined by any of the above methods.

FIG. 4 is a flow chart of a method for waking up a transceiver according to an example embodiment. As shown in FIG. 4, the method may include S401, S402, and S403.

In S401, the terminal receives a wake-up message sent by the network device at a first frequency-domain position through the first receiver.

For example, in this step, the terminal may monitor the wake-up message at the first frequency-domain position through the first receiver.

S402, the terminal wakes up the first transceiver in response to receiving the wake-up message.

For example, when the terminal receives the wake-up message, if the first transceiver is in the sleep state, the first transceiver may exit the sleep state and enter the working state, so as to receive and transmit wireless signals through the first transceiver. If the first transceiver is in a working state, the working state may continue to be maintained.

In some embodiments, after the terminal wakes up the first transceiver, the first receiver may be turned off.

In other embodiments, after the terminal wakes up the first transceiver, the first receiver may continue to be turned on. That is, the wake-up message may continue to be monitored through the first receiver.

In S403, the terminal communicates with the network device at the second frequency-domain position through the first transceiver.

It should be noted that there are many ways for the terminal to communicate with the network device at the second frequency-domain position through the first transceiver. For example, the first transceiver may perform one or more of the following communication modes at the second frequency-domain position: monitoring paging messages, monitoring system messages, performing random access processes, cell selection, cell reselection, PLMN selection, PLMN reselection (for example, the terminal is designated by NAS to perform PLMN reselection), measuring or maintaining synchronization between the terminal and the network device, performing data services or voice services, etc.

In some embodiments, the second frequency-domain position may include a second uplink/downlink initial BWP.

It should be noted that the second frequency-domain position may be the same as or different from the first frequency-domain position.

In some implementations, when the second frequency-domain position is different from the first frequency-domain position, frequency-domain switching may be performed, that is, waking up the first transceiver (for example, turning on the first transceiver), and switching to the second frequency-domain position to communicate with the network device.

For example, if the second frequency-domain position includes a second uplink initial BWP and a second downlink initial BWP, then BWP switching can be performed when the second downlink initial BWP is different from the first downlink initial BWP, that is, waking up the first transceiver, and switching to the second downlink initial BWP to monitor wireless signals.

In other implementations, when the second frequency-domain position is the same as the first frequency-domain position, there is no need to perform frequency-domain switching, that is, waking up the first transceiver, and directly communicating with the network device at the first frequency-domain position.

In this way, the first transceiver can be woken up in response to receiving a wake-up message, and communication with the network device is done through the first transceiver, so that low power consumption can be achieved while also being able to wake up the terminal in time for communication.

In some embodiments of the present disclosure, the second frequency-domain position may be determined by any of the following methods.

Method 1 for determining the second frequency-domain position: determining the second frequency-domain position according to the auxiliary information in the wake-up message.

The auxiliary information may be used to indicate the type of data monitored by the terminal, where the type of data may include the first type and/or the second type.

The first type may include a system message or a system message update. When receiving the first type, the terminal may use the downlink initial BWP configured with the system message monitoring search space as the second frequency-domain position.

For example, when the network device updates the system message, the first type may be carried in the wake-up message, so that the terminal receives the updated system message according to the first type.

In some embodiments, when the network device updates the system message, all the terminals that monitor the wake-up message under the network device may be woken up by the wake-up message.

The second type may include a paging message. When receiving the second type, the terminal may use the downlink initial BWP configured with the paging message monitoring search space as the second frequency-domain position.

In this way, the downlink initial BWP for monitoring the system message is separated from the initial BWP for monitoring the paging message, and the terminal can directly determine the second frequency-domain position according to the service type monitored subsequently, so as to monitor and communicate efficiently.

Method 2 for determining the second frequency-domain position: in response to receiving the second message sent by the network device, determining the second frequency-domain position according to the second message.

The second message may include the second frequency-domain position, and the second frequency-domain position may include the second uplink/downlink initial BWP.

In some embodiments, the second message may be a dedicated message corresponding to the terminal. For example, the second message may be an RRC connection release message or an RRC reconfiguration message corresponding to the terminal.

In other embodiments, the first message may be a broadcast signaling from a network device. For example, the broadcast signaling may include MIB and/or SIB.

For example, when the terminal is a normal user, the terminal may use the uplink/downlink initial BWP (e.g., initial UL/DL BWP), which is configured by the network device for the normal user through broadcast signaling, as the second uplink/downlink initial BWP, and determine the second frequency-domain position according to the second uplink/downlink initial BWP. For example, the second uplink/downlink initial BWP may be used as the second frequency-domain position.

For another example, when the terminal is a Redcap user, the terminal may use the uplink/downlink initial BWP (e.g., Redcap specific initial UL/DL BWP), which is configured by the network device for the Redcap user through broadcast signaling, as the second uplink/downlink initial BWP, and determine the second frequency-domain position according to the second uplink/downlink initial BWP. For example, the second uplink/downlink initial BWP may be used as the second frequency-domain position.

Method 3 for determining the second frequency-domain position: using the second preset frequency-domain position as the second frequency-domain position.

The second preset frequency-domain position may include the second uplink initial BWP and the second downlink initial BWP.

In some embodiments, the second preset frequency-domain position may be a specific frequency-domain position agreed upon by the protocol. For example, the protocol agrees on the second uplink initial BWP and the second downlink initial BWP.

In other embodiments, the second downlink initial BWP in the second preset frequency-domain position may be a downlink initial BWP including COSESET0 and/or SSB. For example, the downlink initial BWP including COSESET0 and/or SSB may be used as the above-mentioned second downlink initial BWP.

In some other embodiments, the second downlink initial BWP in the second preset frequency-domain position may be a downlink initial BWP for monitoring paging messages. For example, the terminal may use the downlink initial BWP for monitoring paging messages as the second downlink initial BWP.

In some other embodiments, the second downlink initial BWP in the second preset frequency-domain position may be the first downlink initial BWP.

In this way, the second preset frequency-domain position may be determined by any one of the above methods.

In some embodiments of the present disclosure, when the first transceiver of the terminal is in the sleep state, the first transceiver may be woken up when any one or more of the following wake-up conditions are met.

Wake-up condition 1: receiving a wake-up message through the first receiver.

In some embodiments, when the first transceiver is in the sleep state, if a wake-up message is received, the first transceiver is woken up.

Wake-up condition 2: receiving a target event indication for the terminal.

In some embodiments, when the first transceiver is in the sleep state, if a target event indication for the terminal is received, the first transceiver is woken up.

The target event indication may be used to indicate the occurrence of any one or more of the following events: monitoring paging messages, monitoring system messages, performing random access processes, cell selection, cell reselection, PLMN selection, PLMN reselection (for example, the terminal is designated by a NAS layer message for PLMN reselection), measuring or maintaining the synchronization between the terminal and the network device, and the terminal actively initiating data services or voice services.

Wake-up condition 3: reaching the target duration, and no wake-up message is received through the first receiver.

In some embodiments, when the first transceiver is in the sleep state, in response to the target duration being reached and no wake-up message being received through the first receiver, the first transceiver is woken up.

The target duration may be any preset duration, such as a duration agreed upon by the protocol, or a duration configured by the terminal. The target duration may also be a duration determined according to a message received from the network device.

In this way, the first transceiver can be woken up when any one or more of the above wake-up conditions are met.

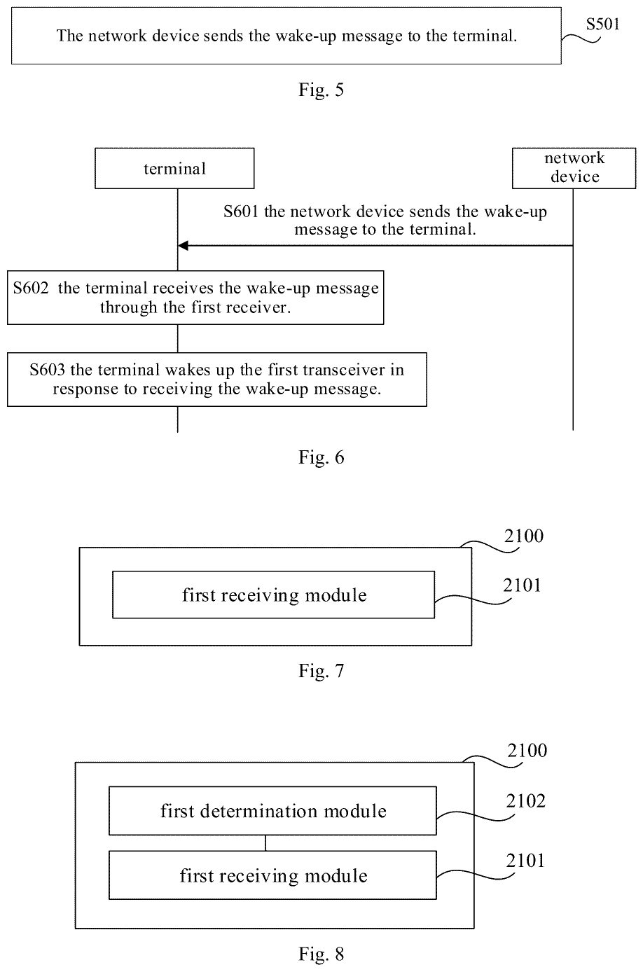

FIG. 5 is a flow chart of a method for waking up a transceiver according to an example embodiment. The method can be applied to a network device in the above communication system. As shown in FIG. 5, the method may include S501.

In S501, the network device sends a wake-up message to the terminal.

The wake-up message is used to instruct the terminal to wake up the first transceiver when the wake-up message is received through the first receiver.

In some embodiments, the terminal may include a first transceiver and a first receiver. The terminal may monitor the wake-up message through the first receiver when the first transceiver is in the sleep state.

In some embodiments, the wake-up message may be a wake-up signal. The wake-up signal may use a wake-up signal already specified in the current protocol, such as WUS, DCP (DCI for power saving), or PEI (Paging Early Indication), etc. The wake-up signal may also be a newly-defined signal type. For example, the wake-up signal may also be a new low power saving signal LP-WUS which is not defined in the current protocol.

In some other embodiments, the wake-up message may include a wake-up indication and/or a wake-up parameter. The terminal may wake up the first transceiver according to the wake-up indication and/or the wake-up parameter.

In the above method, the network device sends a wake-up message to the terminal, and the wake-up message can instruct the terminal to wake up the first transceiver when the wake-up message is received through the first receiver. In this way, the terminal can be supported to set a separate first receiver to receive the wake-up signal, thereby realizing the management of the terminal working state, and improving the power saving performance of the terminal when the first transceiver is in the sleep state.

In some embodiments, the network device may send a wake-up message to the terminal at a first frequency-domain position. The first frequency-domain position may be one or more.

For example, the first frequency-domain position may include the first downlink initial BWP at which the network device sends the wake-up message. For example, it may be a frequency-domain position configured by the network device.

In some embodiments, the first frequency-domain position may be notified to the terminal by the network device through a first message. For example, the network device may send a first message to the terminal, and the first message may be used to instruct the terminal to determine the first frequency-domain position. The first message may include the first frequency-domain position (for example, the first downlink initial BWP).

In some implementations, the first message may be a dedicated message corresponding to the terminal. For example, the first message may be a preset dedicated signaling corresponding to the terminal, and the preset dedicated signaling may include an RRC connection release message or an RRC reconfiguration message. For example, when the terminal enters a non-connected state from a connected state (for example, when the connection is released), the network device may send the first frequency-domain position to the terminal through a preset dedicated signaling. For another example, when the terminal enters a non-connected state from a connected state and the network device estimates that the probability of the terminal receiving a paging message within a first preset time is lower than a preset probability, the network device may send the first frequency-domain position to the terminal through a preset dedicated signaling.

In some other implementations, the first message may be the broadcast signaling from the network device. For example, the broadcast signaling may include a Master Information Block (MIB) and/or a System Information Block (SIB).

For example, the network device may send a downlink initial BWP (for example, LP-WUS-initial DL BWP) dedicated to the wake-up message through a broadcast signaling, for indicating as the first downlink initial BWP.

In other embodiments, the network device may determine the first frequency-domain position (e.g., the first downlink initial BWP) according to the first preset frequency-domain position.

In some implementations, the first preset frequency-domain position may be a specific frequency-domain position agreed upon by the protocol. For example, according to the protocol, the network device sends a wake-up message at the first preset frequency-domain position, and the terminal receives the wake-up message at the first preset frequency-domain position.

In some other implementations, the first preset frequency-domain position may be a downlink initial BWP including COSESET0 and/or SSB. For example, the network device may use the downlink initial BWP including COSESET0 and/or SSB as the first downlink initial BWP.

In some other implementations, the first preset frequency-domain position may be a downlink initial BWP for sending a paging message. For example, the network device may use the downlink initial BWP for sending a paging message as the first downlink initial BWP.

In this way, the first preset frequency-domain position may be determined by any of the above methods.

It should be noted that when the terminal receives the wake-up message, it may wake up the first transceiver and communicate with the network device at the second frequency-domain position through the first transceiver.

In some embodiments, the second frequency-domain position may include a second uplink/downlink initial BWP.

It should be noted that the second frequency-domain position may be the same as or different from the first frequency-domain position.

In some embodiments, the second frequency-domain position may be notified to the terminal by the network device through a wake-up message. For example, the wake-up message may include auxiliary information, which may be used to instruct the terminal to determine the second frequency-domain position.

The auxiliary information may be used to indicate the type of data monitored by the terminal, which may include a first type and/or a second type.

The first type may include a system message or a system message update. The terminal may, upon receiving the first type, use the downlink initial BWP configured with the system message monitoring search space as the second frequency-domain position.

For example, when the network device performs a system message update, the first type may be carried in the wake-up message, so that the terminal receives the updated system message according to the first type.

In some embodiments, when the network device performs a system message update, all the terminals that monitor the wake-up message under the network device may be woken up by the wake-up message.

The second type may include a paging message. The terminal may, upon receiving the second type, use the downlink initial BWP configured with the paging message monitoring search space as the second frequency-domain position.

In this way, the downlink initial BWP for monitoring system messages is separated from the initial BWP for monitoring paging messages, and the terminal can directly determine the second frequency-domain position according to the service type monitored subsequently, so as to monitor and communicate efficiently.

In some other embodiments, the second frequency-domain position may be notified to the terminal by the network device through a second message. For example, the network device may send a second message to the terminal. The second message may be used to instruct the terminal to determine the second frequency-domain position.

The second message may include the second frequency-domain position, and the second frequency-domain position may include the second uplink/downlink initial BWP.

In some embodiments, the second message may be a dedicated message corresponding to the terminal. For example, the second message may be an RRC connection release message or an RRC reconfiguration message corresponding to the terminal.

In some other embodiments, the first message may be a broadcast signaling from the network device. For example, the broadcast signaling may include MIB and/or SIB.

In some other embodiments, the network device may use the second preset frequency-domain position as the second frequency-domain position.

The second preset frequency-domain position may include the second uplink initial BWP and the second downlink initial BWP.

In some embodiments, the second preset frequency-domain position may be a specific frequency-domain position agreed upon by the protocol. For example, the protocol agrees on the second uplink initial BWP and the second downlink initial BWP.

In some other embodiments, the second downlink initial BWP in the second preset frequency-domain position may be a downlink initial BWP including COSESET0 and/or SSB. For example, the downlink initial BWP including COSESET0 and/or SSB may be used as the above-mentioned second downlink initial BWP.

In some other embodiments, the second downlink initial BWP in the second preset frequency-domain position may be a downlink initial BWP for monitoring paging messages. For example, the terminal may use the downlink initial BWP for monitoring paging messages as the above-mentioned second downlink initial BWP.

In some other embodiments, the second downlink initial BWP in the second preset frequency-domain position may be the first downlink initial BWP.

In this way, the second preset frequency-domain position can be determined by any of the above methods.

FIG. 6 is a flow chart of a method for waking up a transceiver according to an example embodiment. As shown in FIG. 6, the method may include S601, S602, and S603.

In S601, a network device sends a wake-up message to a terminal.

In some embodiments, the network device may send a wake-up message to the terminal at a first frequency-domain position.

In S602, the terminal receives the wake-up message through a first receiver.

In some embodiments, the terminal may monitor the wake-up message at the first frequency-domain position through the first receiver.

In some embodiments, when the first transceiver is in the sleep state, the terminal may receive the wake-up message sent by the network device through the first receiver.

In S603, the terminal wakes up the first transceiver in response to receiving the wake-up message.

For example, when the terminal receives a wake-up message, and if the first transceiver is in the sleep state, the terminal may enable the first transceiver to be exited from the sleep state and enter the working state, so as to transmit and receive wireless signals through the first transceiver. If the first transceiver is in the working state, the working state can be maintained.

In some embodiments, after the terminal wakes up the first transceiver, the first receiver may be turned off.

In some other embodiments, after the terminal wakes up the first transceiver, the first receiver may also be kept in an on state. That is, the wake-up message may be monitored continuously through the first receiver.

It should be noted that the specific implementations of the above steps in an embodiment of the present disclosure may refer to the description in the previous embodiment(s) of the present disclosure, and will not be repeated here.

In the above method, the terminal includes a first transceiver and a first receiver. The terminal may receive the wake-up message sent by the network device through the first receiver, and wake up the first transceiver when the wake-up message is received. In this way, by setting a separate first receiver to receive the wake-up signal, the management of the terminal working state can be realized, and the power saving performance of the terminal can be improved when the first transceiver is in the sleep state.

In some embodiments of the present disclosure, when the terminal is in a non-connected state, the above-mentioned first receiver may be used to work. For example, the first receiver may be used to receive a low power wake-up signal, and the low power wake-up signal may be used to wake up the first transceiver. The first transceiver may be the main radio (e.g., the main wireless receiver) of the terminal.

For example, the terminal in the non-connected state may receive a low power wake-up signal (e.g., an LP WUS signal) sent by the network device at a first time-frequency-domain position (e.g., the first downlink initial BWP).

In an embodiment, the first downlink initial BWP is a downlink initial BWP configured by the network to carry and send LP WUS resources.

In an embodiment, the premise for sending LP WUS resources on the first downlink initial BWP is that it contains COSESET0 and/or SSB.

In an embodiment, the first downlink initial BWP is different from the initial DL BWP configured by the existing MIB or SIB1, and is also different from the Redcap specific downlink initial BWP. The first downlink initial BWP is LP-WUS-initial DL BWP.

In an embodiment, for normal users, the first downlink initial BWP is the downlink initial BWP configured by the network device (i.e., the initial DL BWP configured by MIB or SIB1).

In an embodiment, for redcap users: if the Redcap specific downlink initial BWP includes COSESET0 and/or SSB, the first downlink initial BWP is the Redcap specific downlink initial BWP; otherwise, it is the initial DL BWP configured by MIB or SIB1.

In an embodiment, the first downlink initial BWP is the downlink initial BWP used by the terminal to monitor paging messages.

The above-mentioned first downlink initial BWP may be acquired according to the instructions issued by the network device or acquired by the terminal according to the protocol agreement.

In an embodiment, the first downlink initial BWP is notified by the network device through dedicated signaling. For example, the network device sends the first downlink initial BWP to the terminal when notifying the terminal to enter the non-connected state. For another example, if the network device estimates that there will be no paging for the terminal for a period of time, the first downlink initial BWP may be sent to the terminal through dedicated signaling.

In an embodiment, if only one first downlink initial BWP is configured with LP WUS (only one downlink initial BWP is configured with LP-WUS resources) for monitoring (the terminal turns off the main radio at this time), the main radio is turned off and enters the LP WUS monitoring state when the terminal does not detect paging for a period of time.

In an embodiment, if there are more than one first downlink initial BWP for use by the terminal to enter the LP WUS monitoring state (multiple downlink initial BWPs are configured with LP-WUS resources), the terminal may select one of the first downlink initial BWPs to enter the LP WUS monitoring state. For example, but without limitation, the UE ID modulo may be used to determine at which of the first downlink initial BWPs the LP WUS monitoring state is entered.

It should be noted that the first downlink initial BWP may be notified to the terminal in advance through broadcast signaling.

In an embodiment, if the first downlink initial BWP is different from the initial BWP used by the terminal before entering the LP WUS monitoring state, then BWP switching is required at this time (that is, the terminal turns off the main radio at this time, and switches to the first initial BWP for LP-WUS monitoring).

In an embodiment, if the first time-frequency-domain position is different from the second time-frequency-domain position used by the terminal before entering the LP WUS monitoring state, then the transceiver switching is required at this time (that is, the terminal turns off the main radio at this time, and switches to the first time-frequency-domain position for LP-WUS monitoring).

In an embodiment, if the first downlink initial BWP is the same as the initial BWP used by the terminal before entering the LP WUS monitoring state, then there is no need for BWP switching at this time (that is, the terminal turns off the main radio at this time and performs LP-WUS monitoring).

In some embodiments of the present disclosure, after the terminal leaves the LP-WUS monitoring state and turns on the main wireless transceiver, it may work on the second uplink/downlink initial BWP for subsequent operations,

In an embodiment, if the second downlink initial BWP is different from the first downlink initial BWP used by the terminal before leaving the LP WUS monitoring state, then BWP switching is required at this time (that is, the terminal turns on the main radio at this time and switches to the second initial BWP for subsequent data monitoring).

The above-mentioned subsequent operations may include one or more of the following: monitoring paging messages/system messages, performing random access procedures, cell selection/reselection/PLMN selection/PLMN reselection (for example, the terminal is designated by NAS for PLMN reselection); measuring or maintaining synchronization with the network.

In an embodiment, the second uplink/downlink initial BWP may be configured by the network device.

For example, the uplink/downlink initial BWP configured by the network device in the SIB1 message is used as the second uplink/downlink initial BWP.

For another example, for Redcap users, the second uplink/downlink initial BWP may be a Redcap specific uplink/downlink initial BWP.

In an embodiment, the second uplink/downlink initial BWP may be a network device notification or a protocol agreement. The network notification method may be carrying indication information in a low power wake-up message (LP-WUS).

In some embodiments of the present disclosure, when the terminal detects a low power wake-up signal, it may wake up the main wireless transceiver and monitor subsequent data in the second downlink initial BWP.

In an embodiment, the low power wake-up signal may carry auxiliary information, which may assist the terminal in waking up the main radio and monitoring the subsequent data in the second downlink initial BWP.

For example, the low power wake-up signal may carry auxiliary information to indicate the data type of the subsequent monitored data.

It should be noted that if the low power wake-up signal is a wake-up signal for system message update, it is necessary to wake up all the terminals in the cell that monitor the low power wake-up signal.

The data type may include a first type and/or a second type.

The first type may be used to indicate that the monitored data is a system message or a system message update, and is used to indicate that the second downlink initial BWP is a downlink initial BWP configured with a system message monitoring search space.

The second type may be used to indicate that the monitored data is a paging message, and is used to indicate that the second downlink initial BWP is a downlink initial BWP configured with a paging message monitoring search space.

In this way, the downlink initial BWP for system message monitoring and the initial BWP for paging are separated, and the terminal can directly know which downlink initial BWP needs to be monitored according to the service type monitored subsequently.

In an embodiment, the second downlink initial BWP may be a protocol agreement. For example, it may be a downlink initial BWP for monitoring paging messages.

In some embodiments of the present disclosure, if the monitoring mode duration of the terminal using the above-mentioned first receiver times out, the terminal operates in the second downlink initial BWP. For example, the second downlink initial BWP may be the first downlink initial BWP used by the terminal before leaving the LP WUS monitoring state.

FIG. 7 is a block diagram of an apparatus 2100 for waking up a transceiver according to an example embodiment. The apparatus may be applied to a terminal, the terminal including a first transceiver and a first receiver. As shown in FIG. 7, the apparatus 2100 may include a first receiving module 2101.

The first receiving module 2101 is configured to receive a wake-up message sent by a network device through the first receiver in a case that the first transceiver is in a sleep state, where the wake-up message is used to wake up the first transceiver.

In some embodiments, the first receiving module 2101 is configured to receive the wake-up message sent by the network device through the first receiver at a first frequency-domain position.

In some embodiments, the first frequency-domain position includes the first downlink initial BWP at which the network device sends the wake-up message.

In some embodiments, the apparatus further includes a first determination module.

FIG. 8 is a block diagram of an apparatus 2100 for waking up a transceiver according to an example embodiment. As shown in FIG. 8, the apparatus 2100 may further include a first determination module 2102.

The first determination module 2102 is configured to: determine the first frequency-domain position according to the first message in response to receiving the first message sent by the network device; or use the first preset frequency-domain position as the first frequency-domain position.

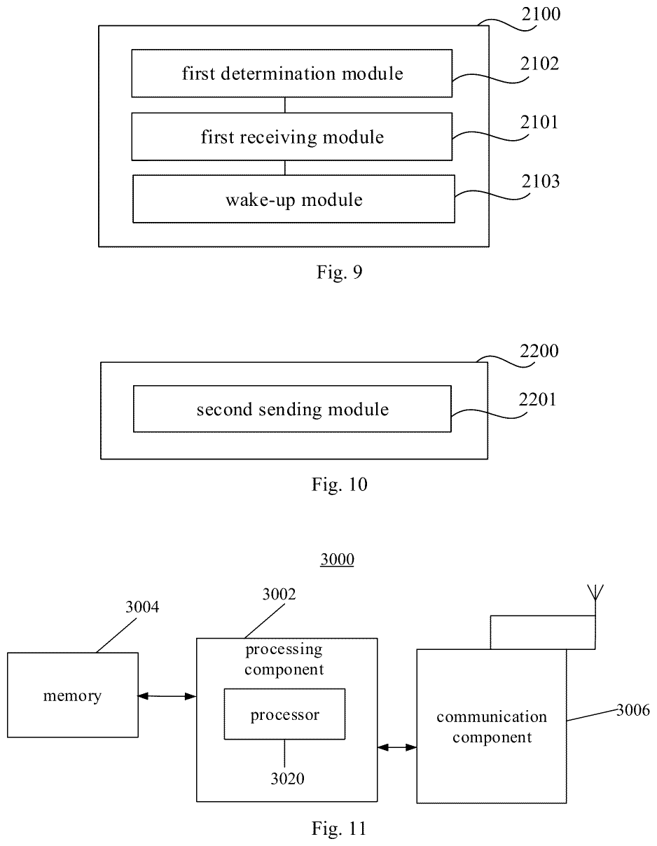

FIG. 9 is a block diagram of an apparatus 2100 for waking up a transceiver according to an example embodiment. As shown in FIG. 9, the apparatus 2100 may further include a wake-up module 2103.

The wake-up module 2103 is configured to: wake up the first transceiver in response to receiving the wake-up message; and communicate with the network device at the second frequency-domain position through the first transceiver.

In some embodiments, the first determination module 2102 is further configured to: determine the second frequency-domain position according to the second message in response to receiving a second message sent by the network device; determine the second frequency-domain position according to the auxiliary information in the wake-up message; or use the second preset frequency-domain position as the second frequency-domain position.

In some embodiments, the wake-up module 2103 is further configured to: in a case that the first transceiver is in the sleep state, wake up the first transceiver if a target event indication for the terminal is received.

In some embodiments, the wake-up module 2103 is configured to: in a case that the first transceiver is in the sleep state, wake up the first transceiver in response to a target duration being reached and not receiving the wake-up message by the first receiver.

FIG. 10 is a block diagram of an apparatus 2200 for waking up a transceiver according to an example embodiment. The apparatus can be applied to a network device. As shown in FIG. 10, the apparatus 2200 may include a second sending module 2201.

The second sending module 2201 is configured to send a wake-up message to a terminal, where the wake-up message is used to instruct the terminal to wake up the first transceiver in response to the wake-up message being received through the first receiver.

In some embodiments, the second sending module 2201 is configured to send the wake-up message to the terminal at a first frequency-domain position.

In some embodiments, the first frequency-domain position includes the first downlink initial BWP at which the network device sends the wake-up message.

In some embodiments, the second sending module 2201 is further configured to send a first message to the terminal, where the first message is used to instruct the terminal to determine the first frequency-domain position.

In some embodiments, the wake-up message includes auxiliary information, where the auxiliary information is used to instruct the terminal to determine the second frequency-domain position.

In some embodiments, the second sending module 2201 is further configured to send a second message to the terminal, where the second message is used to instruct the terminal to determine the second frequency-domain position.

Regarding the apparatus in the above embodiment(s), the specific way in which each module performs the respective operation has been described in detail in the method embodiment(s), and will not be elaborated here.

FIG. 11 is a block diagram of a device for waking up a transceiver according to an example embodiment. The device 3000 for waking up a transceiver may be a terminal in the communication system shown in FIG. 1, or a network device in the communication system. Referring to FIG. 11, the device 3000 may include one or more of the following components: a processing component 3002, a memory 3004, and a communication component 3006.

The processing component 3002 may be used to control the overall operation of the device 3000, such as operations associated with display, phone calls, data communications, camera operations, and recording operations. The processing component 3002 may include one or more processors 3020 to execute instructions for completing all or some of the steps of the above-mentioned method for waking up a transceiver. In addition, the processing component 3002 may include one or more modules to facilitate the interaction between the processing component 3002 and other components. For example, the processing component 3002 may include a multimedia module to facilitate the interaction between the multimedia component and the processing component 3002.

The memory 3004 is configured to store various types of data to support the operation of the device 3000. Examples of such data include instructions for any application or method operating on the device 3000, contact data, phone book data, messages, pictures, videos, etc. The memory 3004 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk, or optical disk.

The communication component 3006 is configured to facilitate wired or wireless communication between the device 3000 and other devices. The device 3000 may access a wireless network based on a communication standard, such as Wi-Fi, 2G, 3G, 4G, 5G, 6G, NB-IOT, eMTC, etc., or a combination thereof. In an example embodiment, the communication component 3006 receives a broadcast signal or broadcast-related information from an external broadcast management system via a broadcast channel. In an example embodiment, the communication component 3006 also includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology, and other technologies.

In an example embodiment, the device 3000 may be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to perform the above-mentioned method for waking up a transceiver.

The above-mentioned device 3000 may be an independent electronic device or a part of an independent electronic device. For example, in an embodiment, the electronic device may be an integrated circuit (IC) or a chip. The integrated circuit may be an IC or a collection of multiple ICs. The chip may include, but is not limited to, the following types: Graphics Processing Unit (GPU), Central Processing Unit (CPU), Field Programmable Gate Array (FPGA), Digital Signal Processor (DSP), Application Specific Integrated Circuit (ASIC), System on Chip (SoC), etc. The above-mentioned integrated circuit or chip may be used to execute executable instructions (or codes) to implement the above-mentioned method for waking up a transceiver. The executable instructions may be stored in the integrated circuit or chip, or may be obtained from other devices or equipment, such as the integrated circuit or chip including a processor, a memory, and an interface for communicating with other devices. The executable instructions may be stored in the processor. When the executable instructions are executed by the processor, the above-mentioned method for waking up a transceiver is implemented. Alternatively, the integrated circuit or chip may receive the executable instructions through the interface and transmit them to the processor for execution, so as to implement the above-mentioned method for waking up a transceiver.

In an example embodiment, the present disclosure also provides a computer-readable storage medium on which computer program instructions are stored. When the program instructions are executed by the processor, the steps of the method for waking up a transceiver provided by the present disclosure are implemented. For example, the computer-readable storage medium may be a non-transitory computer-readable storage medium including instructions, for example, the above-mentioned memory 3004 including instructions. The above-mentioned instructions may be executed by the processor 3020 of the device 3000 to complete the above-mentioned method for waking up a transceiver. For example, the non-transitory computer-readable storage medium may be a ROM, a random access memory (RAM), a CD-ROM, a magnetic tape, a floppy disk, an optical data storage device, etc.

In another example embodiment, a computer program product is also provided, which includes a computer program executable by a programmable device. The computer program has a code portion used for performing the above-mentioned method for waking up a transceiver when executed by the programmable device.

After considering the specification and practicing the present disclosure, those skilled in the art will easily think of other embodiments of the present disclosure. The present application is intended to cover any modification, use or adaptation of the present disclosure, which follows the general principles of the present disclosure and includes common knowledge or customary technical means in the technical field that are not disclosed in the present disclosure. The description and examples are to be regarded as instances only, and the true scope and spirit of the present disclosure are indicated by the following claims.

It should be understood that the present disclosure is not limited to the precise structure described above and shown in the drawings, and various modifications and changes may be made without departing from its scope. The scope of the present disclosure is limited only by the appended claims.

1. A method for waking up a transceiver, performed by a terminal, wherein the terminal comprises a first transceiver and a first receiver, and the method comprises:
in a case that the first transceiver is in a sleep state, receiving a wake-up message sent by a network device through the first receiver, wherein the wake-up message is used to wake up the first transceiver.

2. The method according to claim 1, wherein receiving the wake-up message sent by the network device through the first receiver comprises:
receiving the wake-up message sent by the network device through the first receiver at a first frequency-domain position.

3. The method according to claim 2, wherein the first frequency-domain position comprises a first downlink initial bandwidth part (BWP).

4. The method according to claim 2, wherein the first frequency-domain position is determined by:
in response to receiving a first message sent by the network device, determining the first frequency-domain position according to the first message; or
using a first preset frequency-domain position as the first frequency-domain position.

5. The method according to claim 1, further comprising:
in response to receiving the wake-up message, waking up the first transceiver;
communicating with the network device at a second frequency-domain position through the first transceiver.

6. The method according to claim 5, wherein the second frequency-domain position is determined by:
in response to receiving a second message sent by the network device, determining the second frequency-domain position according to the second message;
determining the second frequency-domain position according to auxiliary information in the wake-up message; or
using a second preset frequency-domain position as the second frequency-domain position.

7. The method according to claim 1, further comprising:
in a case that the first transceiver is in the sleep state, waking up the first transceiver in response to receiving a target event indication.

8. The method according to claim 1, further comprising:
in a case that the first transceiver is in the sleep state, waking up the first transceiver in response to a target duration being reached and not receiving the wake-up message through the first receiver.

9. A method for waking up a transceiver, performed by a network device, the method comprising:
sending a wake-up message to a terminal, wherein the wake-up message is used to instruct the terminal to wake up a first transceiver in response to the wake-up message being received through the first receiver.

10. The method according to claim 9, wherein sending the wake-up message to the terminal comprises:
sending the wake-up message to the terminal at a first frequency-domain position.

11. The method according to claim 10, wherein the first frequency-domain position comprises a first downlink initial bandwidth part (BWP).

12. The method according to claim 10, further comprising:
sending a first message to the terminal, wherein the first message is used to instruct the terminal to determine the first frequency-domain position.

13. The method according to claim 9, wherein the wake-up message comprises auxiliary information, the auxiliary information being used to instruct the terminal to determine a second frequency-domain position.

14. The method according to claim 9, further comprising:
sending a second message to the terminal, wherein the second message is used to instruct the terminal to determine a second frequency-domain position.

15. (canceled)

16. (canceled)

17. A terminal, comprising:
a first transceiver and a first receiver;
a processor; and
a memory for storing processor-executable instructions,
wherein the processor is configured to:
in a case that the first transceiver is in a sleep state, receive a wake-up message sent by a network device through the first receiver, wherein the wake-up message is used to wake up the first transceiver.

18. (canceled)

19. (canceled)

20. The terminal according to claim 17, wherein the processor is further configured to:
receive the wake-up message sent by the network device through the first receiver at a first frequency-domain position.

21. The terminal according to claim 17, wherein the processor is further configured to:
in response to receiving the wake-up message, wake up the first transceiver; and
communicate with the network device at a second frequency-domain position through the first transceiver.

22. The terminal according to claim 17, wherein the processor is further configured to:
in a case that the first transceiver is in the sleep state, wake up the first transceiver in response to receiving a target event indication.

23. The terminal according to claim 17, wherein the processor is further configured to:
in a case that the first transceiver is in the sleep state, wake up the first transceiver in response to a target duration being reached and not receiving the wake-up message through the first receiver.

24. A network device, comprising:
a processor; and
a memory for storing processor-executable instructions,
wherein the processor is configured to perform the method according to claim 9.
